(19) United States
(12) Patent Application Publication
(10) Pub. No.: US 2006/0064519 A1
(43) Pub. Date: Mar. 23, 2006

(54) Interface mediator for a computing device

(76) Inventor: John Andrew Patterson, Windsor (CA)

Correspondence Address: STEUBING MCGUINNESS & MANARAS LLP, 125 NAGOG PARK, ACTON, MA, 01720, US

(21) Appl. No.: 10/945,493

(22) Filed: Sep. 20, 2004

(51) Int. Cl. G06F 3/06

(52) U.S. Cl. 710/36

(57) ABSTRACT

A interface mediator for a computing device is disclosed for providing mediation between a port of the computing device and a device normally connected to that port. The interface mediator for a computing device includes a processing unit for executing a control program; a first mediator port connected to said second processing unit for connection to the device normally connected to the computing device; a second mediator port connected to the processing unit for connection to port of the computing device; and a memory provision means for providing storage for a control program; whereby in use the device is connected to the first mediator port, the second mediator port is connected to said the computing device port, and the processing unit can mediate data communicated between the computing device port and the device. The mediation may include deletion, addition, or modification of the data.

### FIELD OF THE INVENTION

The present invention relates to an interface mediator for a computing device and is particularly concerned with providing an apparatus which can monitor and control signals between a computing device and interface units.

### BACKGROUND OF THE INVENTION

In many uses associated with computing devices, external devices are connected to the computing device via input and output ports associated with the computing device. In the case of input ports, events transpiring in the environment are converted into data, and the resultant data is communicated to the computing device via the input port. A common example is that of keyboards which translate particular tactile inputs into data communicated to a keyboard (input) port.

Likewise, in the case of output ports, data originating in the computing device is produced at the output port, communicated to the device, and the device uses the data to control some aspect of its function. A common example in this regard is a printer, wherein data produced at a computing device's printer (output) port is communicated to the printer, thereby resulting in the production of some sort of graphic image.

A further example includes that of input/output ports in which the data is communicated both to and from the device connected to the computing device's port. A common example of such an application is a telephony interface device such as a modem.

In computing device configurations as described above, there is a direct data connection between the computing device port and the device. This direct data connection provides no opportunity for control of the data stream between the computing device port and the device.

In view of the foregoing, it would be desirable to provide an interface mediator for a computing device which overcomes the above-described inadequacies and shortcomings.

### SUMMARY OF THE INVENTION

An object of the present invention is to provide an improved interface mediator for a computing device.

According to an aspect of the present invention there is provided an interface mediator for use with a computing device having a first processing unit and a first computing device port connected to the first processing unit, where the first computing device port is for connection to a first device. The interface mediator has a second processing unit for executing a control program; a first mediator port connected to the second processing unit for connection to the first device; a second mediator port connected to the second processing unit for connection to the first port of the computing device; and a memory provision means for providing storage for the control program. In use the first device is connected to said the mediator port, the second mediator port is connected to the first computing device port, and the second processing unit can mediate data communicated between first computing device port and said first device.

Advantages of the present invention include the ability to monitor, control and troubleshoot the data stream which flows between the computing device and the first device.

Conveniently the memory provision means may be a fixed or removable memory. Removable memories could be a memory card, or a disc drive for removable media, such as a floppy disc or a CDROM. Fixed memories could included programmable RAM or hard drives.

Conveniently, when the computing device port is an input port, the device may be any of acoustic sensing means, light sensing means, radio signal sensing means, or tactile sensing means. Where the device is a tactile sensing means, it may be one of the group of a keyboard, a keypad, a touchpad, a slide pot, a knob, a pressure mat, a mouse, a trackball, and a data glove.

Conveniently, when the computing device port is an output port, the device may be any of a wireless communications apparatus, an infrared communications apparatus, a set of switched contacts under the control of data from the computing device port, an electrical power provision apparatus, a display apparatus, or a printer.

Conveniently, when the computing device port is an network port, the device may be any telephony network interface apparatus, for example a modem; a digital network interface apparatus, or a wireless network interface apparatus.

Conveniently, there may be a plurality of mediator port pairs, each pair having one port of the pair for connecting to a port of a device and the other associated port of the pair for connecting to a port of the computing device associated with the device; and wherein the second processing unit can mediate data communicated between the computing device port and the associated device.

According to another aspect of the invention there is provided a separate signal mediating unit adapted to be mounted within the computing device having an input connector; an output connector; at least one of sensing or disconnect means between input and output connector; and communication means between the separate signal mediating unit for the second processing unit to communicate with the at least one of sensing or disconnect means.

Conveniently, there may be a third mediator port connected to a trigger device. The trigger device may be any of acoustic sensing means, light sensing means, radio signal sensing means, or tactile sensing means. Where the trigger device is a tactile sensing means, it may be one of the group of a keyboard, a keypad, a touchpad, a slide pot, a knob, a pressure mat, a mouse, a trackball, and a data glove. Alternatively, the trigger device may be a third information processor.

The present invention will now be described in more detail with reference to exemplary embodiments thereof as shown in the appended drawings. While the present invention is described below with reference to the preferred embodiments, it should be understood that the present invention is not limited thereto. Those of ordinary skill in the art having access to the teachings herein will recognize additional implementations, modifications, and embodiments which are within the scope of the present invention as disclosed and claimed herein.

### BRIEF DESCRIPTION OF THE DRAWINGS

The invention will be further understood from the following detailed description of embodiments of the invention and accompanying drawings in which:

FIG. 1 is a diagram of a computing device with a video screen, keyboard and mouse according to the prior art.

FIG. 2 is a diagram of an interface mediator connected to computing device with a video screen, keyboard and mouse according to an embodiment of the invention.

FIG. 3 is a diagram of an interface mediator connected to computing device and ancillary peripheral devices according to an embodiment of the invention.

FIG. 4 is a diagram of an interface mediator connected to computing devices and their associated peripheral devices according to an alternative embodiment of the invention.

FIG. 5 is a diagram of a networked plurality of interface mediators connected to associated computing and peripheral devices according to an alternative embodiment of the invention.

FIG. 6 is a diagram of an interface mediator connected to a computing device and associated peripheral devices according to an application of an embodiment of the invention.

FIG. 7 is a diagram of an interface mediator connected to a computing device and an auxiliary mediation interface according to an alternative embodiment of the invention.

FIG. 8 is a diagram of an interface mediator connected to a computing device and associated peripheral devices having a further trigger device attached to the interface mediator according to an alternative embodiment of the invention.

FIG. 9 is a diagram of an interface mediator connected to a computing device and an additional input device and a plurality of network interface devices according to an alternative embodiment of the invention.

FIG. 10 is a diagram of an interface mediator connected to a computing device and a device to which power is provided according to an alternative embodiment of the invention.

FIG. 11 is a diagram of an interface mediator connected between a pair of computing devices according to an alternative embodiment of the invention.

### DETAILED DESCRIPTION

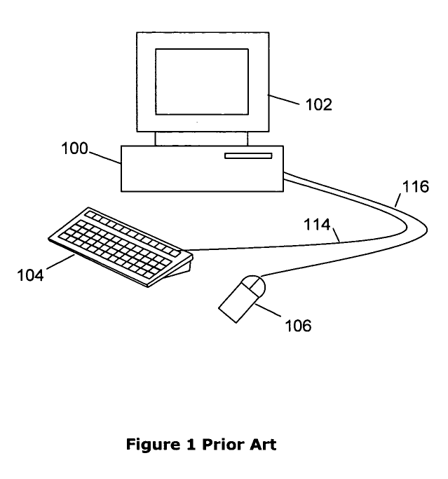

Referring to FIG. 1 there may be seen a computing device 100 having an associated video terminal 102. Keyboard 104 connects via interface cable 114 to computing device 100. Likewise, pointing device (e.g. computer mouse) 106 connects via interface cable 114 to computing device 100.

In operation, keyboard 104 transforms tactile signals from a user into a format which is conveyed over the interface cable 114 to computing device 100 for processing according to predetermined instructions. Likewise, pointing device 106 transforms movements by a user into a signal which is conveyed over the interface cable 116 to computing device 100 for processing according to predetermined instructions. As is well known in the art, the predetermined instructions commonly result in modifications to images presented upon video terminal 102—an example of an output device.

In general, computing device 100 receives inputs from input devices via input ports (not shown), processes these inputs according to predetermined instructions, and produces outputs at output ports (not shown) which are conveyed via interface means to output devices. Under many circumstances, input and output ports are combined into so called I/O ports for the bidirectional transfer of signals. Examples may be ports which are generally controlling external devices (output ports) but which receive status information from the device under control. Other examples of bidirectional information transfer include networking ports wherein computing device 100 would exchange information with other computing devices. Note: for the purposes of this disclosure, the terms information and signals are intended to be synonymous with data transfers between devices. Such data transfers are well known to those skilled in the art and include a multitude of connection schemes and methods as described by various technical communications standards.

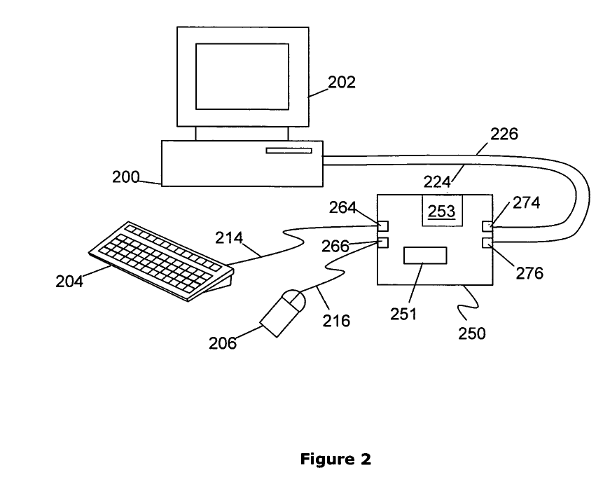

Referring to FIG. 2, there may be seen a computing device 200, having associated video terminal 202, keyboard 204, and pointing device 206. Interface cable 214 connects keyboard 204 to interface mediator 250 at interface port 264. Likewise, interface cable 216 connects pointing device 206 to interface mediator 250 at interface port 266. Computing device 200 also connects to interface mediator 250 via interface cable 224 to interface port 274 and via interface cable 226 to interface port 276. Within interface mediator 250 are processing unit 251 and removable memory device 253.

Processing unit 251 is an information processor, for example an integrated circuit central processing unit (CPU) used to execute software code in order to control the operation of interface mediator 250. Associated with the information processor are the usual ancillary devices known to those skilled in the art as necessary to the operation of an information processor, such as quartz timing crystals, decoupling capacitors, timing and buffer circuitry, flash memory circuits, power supply circuitry, memory for the operating system, etc.

The memory device store the instructions used to control the operation of information processor 251. Removable memory device 253 may be a memory card, such an SD memory card manufactured in accordance with the Secure Digital memory standard. Alternatively, removable memory device 253 may be a USB drive. Embodiments of the invention which utilize a memory card could have the memory card loaded by some separate processor.

The memory device is not limited to a memory card, but could in certain embodiments be a disc drive, such as a floppy disc or CDROM drive.

Alternatively, in other embodiments the memory need not be removable. For example, the memory device could be a bank of RAM programmable by an input memory port. Alternatively, the memory device could be a resident hard drive.

In operation, data received on input ports 264 and 266 is mediated by information processor 251 according to the instructions in memory device 253, and output on ports 274 and 276 respectively, for input to computing device 200.

For the purposes of this specification, the term mediation encompasses the modification of an incoming data stream before outputting the resultant modified data stream. The modification could involve deletion, addition, or modification of the data stream.

Typically, the mediation will be triggered by contents of the data stream that is being mediated. For example, in the case of the keyboard 204, the presence of a particular key sequence appearing in the data stream presented to interface port 264 could trigger the addition of a sequence of characters at interface port 274.

Under other conditions the mediation of one data stream may be triggered by the contents of another data stream. As way of example, a particular data stream associated with movements of pointing device 206 could act as a trigger which would cause information processor 251 to mediate the data stream generated appearing at interface port 264 so as to present all capital letters at interface port 274, regardless of the case of the letter typed on keyboard 204.

It is important to note in the examples above that mediation device 250 is not necessarily known to computing device 200. The mediating actions occurs due to the program instructions contained in memory device 253, and the contents of the data streams being presented to the interface ports 264 and 266. As is apparent, both mediations triggered by the contents of a particular data stream, and mediations triggered by the contents of a data stream associated with a different mediator interface port are possible.

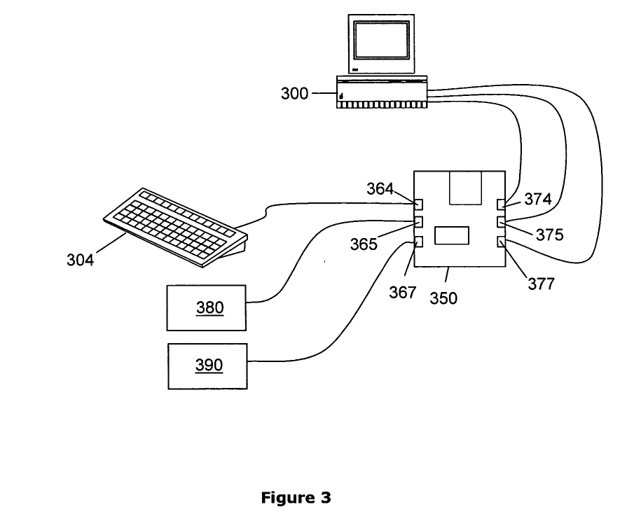

Referring now to FIG. 3, there may be seen a more general example of an interface mediator 350 associated with a computing device 300. Keyboard 304 connects to interface port 364, and interface port 374 connects to the keyboard interface port (not shown) of computing device 300. Generic input device 380 connects to interface port 365, and interface port 375 connects to the input port (not shown) of computing device 300 that computing device 300 associates with input device 380. Likewise, generic output device 390 connects to interface port 367, and interface port 377 connects to the output port (not shown) of computing device 300 that computing device 300 associates with input device 390. In this embodiment, interface mediator can mediate the data streams from keyboard 304 and input device 380 and the data stream to output device 390. The mediations can be triggered by elements in any of the data streams.

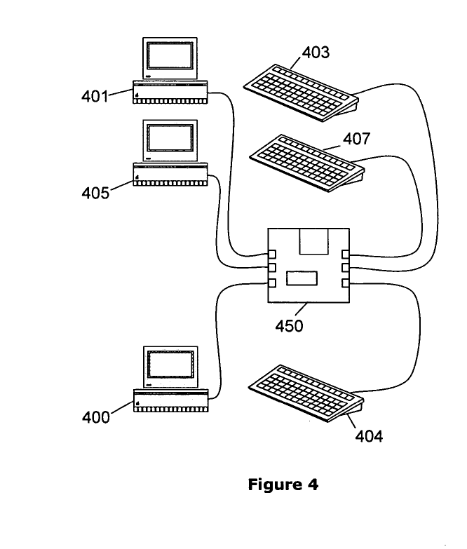

Referring now to FIG. 4, there may be seen an alternative embodiment of the invention wherein interface mediator 450 intermediates between the keyboards of a plurality of computing devices. Computing device 400 has associated keyboard 404. Likewise computing device 401 has associated keyboard 403, and computing device 405 has associated keyboard 407. As interface mediator 450 mediates all of the keyboard data streams, the mediation performed on any individual data stream may be triggered by either the data stream itself, or a data stream associated with one of the other keyboards. An example application which could take advantage of this configuration might be where an operator responsible for the performance of other computers working at keyboard 404 and computing device 400, could via appropriate trigger cues entered on keyboard 404, gain control of either keyboard 403 or 407. Such control would be of use when debugging problems associated with the functioning of computing devices 401 or 405.

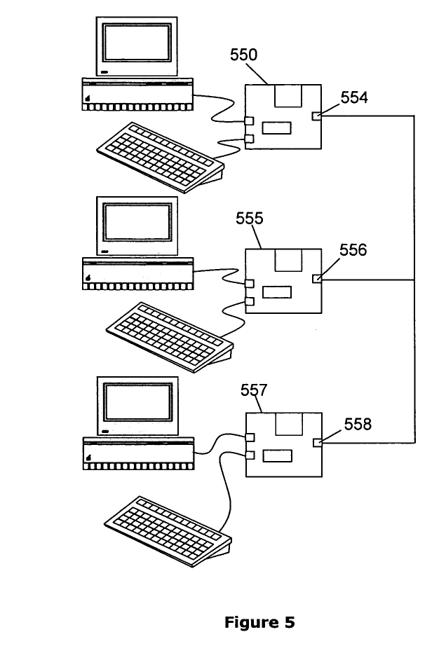

Referring now to FIG. 5, there may be seen an alternative embodiment wherein a plurality of interface mediators 550, 555, and 557 each mediate the keyboard for an associated computing device. The plurality of interface mediators each have a respective interface port 554, 556, and 558 which are interconnected. The processing unit on the interface mediator can utilize the interface port in a manner similar to any of the other interface ports it is equipped with, and therefore have mediation triggers associated with these interface ports. This configuration may offer advantages in terms of interconnection cabling over the embodiment depicted in FIG. 4, especially in situations where the computing devices are located at some distance from each other.

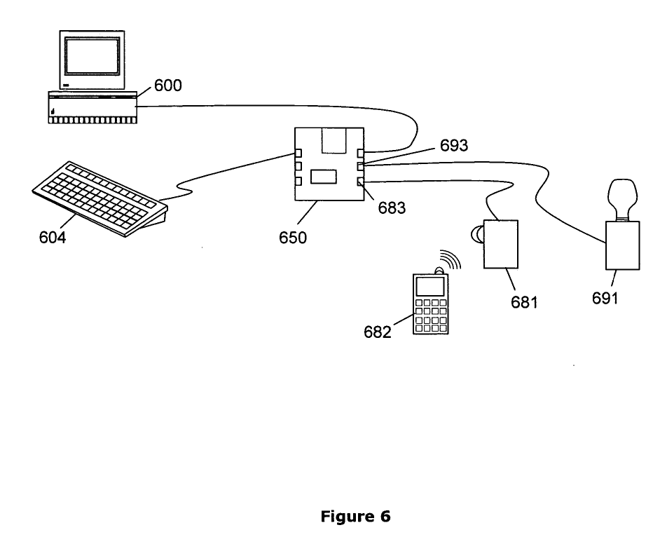

Referring now to FIG. 6, there is an alternative embodiment wherein interface mediator 650, acting as a mediator between computing device 600 and associated keyboard 604, has an infrared sensing device 681 connected to mediator interface port 683, and a lamp 691 connected to mediator interface port 693. In this configuration, interface mediator 650 can monitor the data stream provided by infrared sensing device 681, and when determining that a particular trigger is present, can actuate lamp 691 via sending an appropriate data stream on mediator interface port 693. Note that this mediation could be triggered via an infrared signal from a device such as personal digital assistant (PDA) 682. In this embodiment, interface mediator provides for an additional layer of control and response beyond that provided by computing device 600.

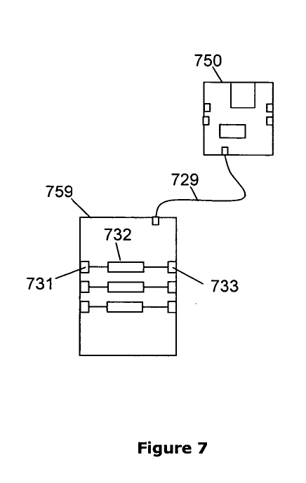

Referring to FIG. 7, there may be seen an alternative embodiment of the invention which provides for enhanced functionality in applications where it is desired to mediate connections which may not run external to a computing device. Interface mediator 750 has connected to it a separate signal mediating unit 759 via communications link 729. Signal mediating unit 759 is adapted to be mounted within a computing device. Signal mediating unit 759 may be configured as a plug in card conforming to the standards for plug in accessories for the computing device, or alternatively may be a module which is physically secured within the computing device. Signal mediating unit 759 has at least one pair of associated connectors, 731 and 733. Between and connected to these connectors is a sensing or disconnect means 732. Connectors 731 and 733 are appropriate to the connection to be mediated, for example a power supply lead, or connections to a disc drive. By means of communication link 729, interface mediator 750 may alternatively sense or disconnect the connection or connections being mediated by signal mediation unit 759. Applications for this embodiment include, for example, disconnection of compromised disc drives should a security trigger be received by interface mediator 750. By appropriate choice of connectors 731 and 733, and sensing/disconnect means 732, the interface mediator 750 may monitor and effect control over multiple aspects of the computing device into which the signal mediating unit 759 is installed.

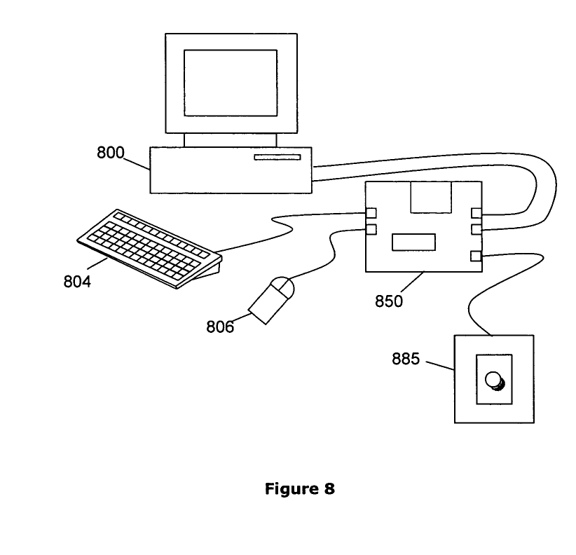

Referring to FIG. 8, there may be seen an alternative embodiment in which computing device 800 and its associated peripherals 804 and 806 are connected via interface mediator 850. Also connected to interface mediator 850 is alarm trigger 885. This alarm trigger could be a sensing device or alternatively some form of input device such as a panic button. Data stream activity originating in alarm trigger 885 would trigger interface mediator 850. The results of the trigger could be manifold according to the instructions programmed into interface mediator 850. For example, in the configuration shown in FIG. 8, a trigger event occurring at alarm trigger 885 could result in interface mediator 850 interjecting a sequence of key strokes into computing device 800 which would initiate various alarm functions and then shutdown activity within computing device 800. Alarm trigger 885 could represent a wide variety of devices, as long as a particular data stream could be defined as a trigger for interface mediator 850.

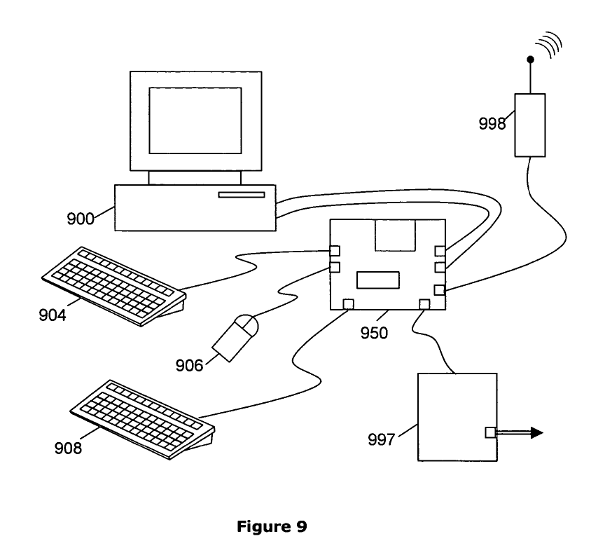

Referring now to FIG. 9, there may be seen an alternative embodiment of the invention in which computing device 900 having associated keyboard 904 and pointing device 906 are connected via interface mediator 950 as in previously described embodiments. Also connected to interface mediator 950 are auxiliary keyboard 908, modem 997 and wireless modem 998. Interface mediator 950 can be triggered by data received on devices 908, 997 and 998 to initiate mediate the keyboard data stream into computing device 900. This mediation could have application, as an example, when a remote keyboard for computing device 900 is desired, or alternatively if some intervention via modem is desired. A network administrator responsible for the functioning of computing device 900 could trigger desired data streams via any of the devices 908, 997 and 998, so as to remotely accomplish a function which would otherwise require physical presence at keyboard 904. Alternatively, interface mediator 950 would allow computing device 900 to monitor activity on any of the devices 908, 997 and 998, by interface mediator providing a log entry via keyboard mediation when any triggering activity occurs.

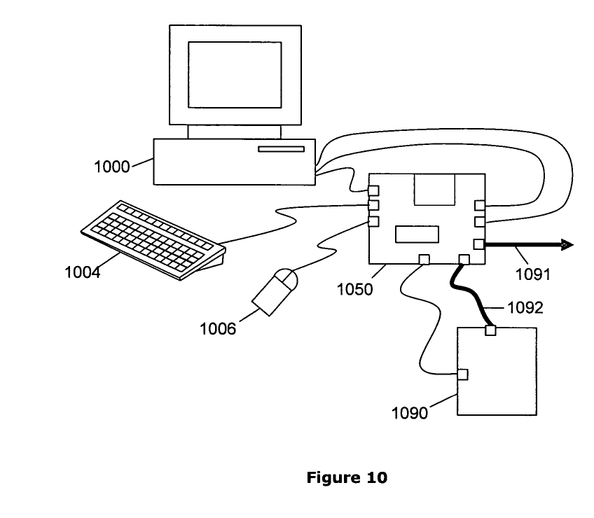

Referring now to FIG. 10, there may be seen an alternative embodiment of the invention in which computing device 1000 having associated keyboard 1004 and pointing device 1006 are connected via interface mediator 1050 as in previously described embodiments. Also connected to computing device 1000 via interface mediator 1050 is printer 1090. As per the previously described embodiments, interface mediator 1050 can mediate the data stream from computing device 1000 to printer 1090. In this embodiment interface mediator 1050 further mediates the power input 1091 provided to printer 1090 via power cable 1092. In this embodiment interface mediator 1050 mediates the supply of power as conditioned by triggers recognized by the programming instructions governing its operation. In practise printer 1090 could be disabled unless a particular password was provided keyboard 1004. Interface mediator 1050 thereby provides an additional layer or level of control in this configuration. Alternatively, the printer output data stream can be monitored, providing a measure of problem isolation should troubleshooting be required.

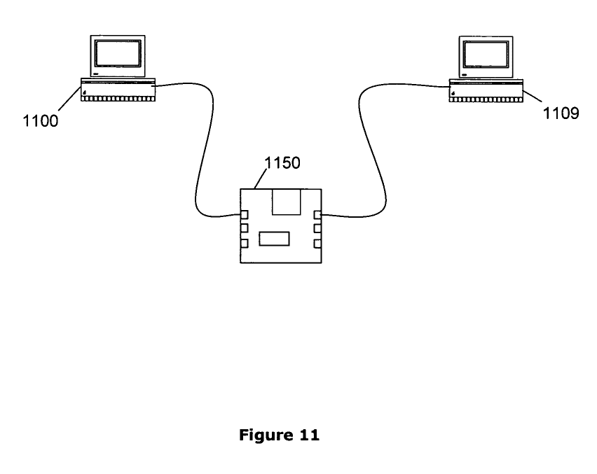

Referring now to FIG. 11, there may be seen an alternative embodiment of the invention in computing device 1100 is connected to second computing device 1109 via interface mediator 1150. This embodiment is illustrative of a configuration where an interface mediator mediates the data stream between two processing units, as opposed to between a processing unit and an input or output device. This embodiment of the invention has applications, as do the previous embodiments, in monitor, control, and troubleshooting.

Under a contemplated alternative configuration related to the configuration depicted in FIG. 11, an interface mediator could be used to mediate a connection between two other interface mediators. Such a configuration would allow hierarchical networks of interface mediators to be established, further extended the capabilities over that of a single interface mediator.

Therefore, what has been disclosed are embodiments where an apparatus for mediating a data stream between a computing device and other devices is provided. The interface mediator has application in monitoring, control and troubleshooting, as well as providing the capability to enhance and elaborate data streams as the data streams flow from device to device.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. An interface mediator for use with a computing device having a first processing unit and a first computing device port connected to said first processing unit, said first computing device port for connection to a first device;
said interface mediator comprising:
a second processing unit for executing a control program;
a first mediator port connected to said second processing unit for connection to said first device;
a second mediator port connected to said second processing unit for connection to said first port of said computing device; and
a memory provision means for providing storage for said control program;
whereby in use said first device is connected to said first mediator port, said second mediator port is connected to said first computing device port, and said second processing unit can mediate data communicated between first computing device port and said first device.

2. An interface mediator as claimed in claim 1 wherein said memory provision means is removable.

3. An interface mediator as claimed in claim 2 wherein said memory provision means is a memory card.

4. An interface mediator as claimed in claim 1 wherein said memory provision means is a memory drive.

5. An interface mediator as claimed in claim 4 wherein said memory drive is a magnetic disk drive.

6. An interface mediator as claimed in claim 4 wherein said magnetic disc drive is a floppy disk drive.

7. An interface mediator as claimed in claim 4 wherein said memory drive is an optical disk drive.

8. An interface mediator as claimed in claim 7 wherein said optical disk drive is an CDROM.

9. An interface mediator as claimed in claim 1 wherein said memory provision means comprises a first memory for storage of operating system instructions;
a second memory for storage of programming instructions; and
a port for loading said second memory.

10. An interface mediator as claimed in claim 10 wherein said second memory is RAM.

11. An interface mediator as claimed in claim 10 wherein said second memory is a read-write disc drive.

12. An interface mediator as claimed in claim 1 wherein said first computing device port is an input port.

13. An interface mediator as claimed in claim 12 wherein said first device is an acoustic sensing means.

14. An interface mediator as claimed in claim 12 wherein said first device is an optical radiation sensing means.

15. An interface mediator as claimed in claim 12 wherein said first device is a radio signal sensing means.

16. An interface mediator as claimed in claim 12 wherein said first device is a tactile input sensing means.

17. An interface mediator as claimed in claim 16 wherein said tactile input sensing means is one of the group of a keyboard, a keypad, a touchpad, a slide pot, a knob, a pressure mat, a mouse, a trackball, and a data glove.

18. An interface mediator as claimed in claim 1 wherein said first computing device port is an output port.

19. An interface mediator as claimed in claim 18 wherein said first device is a wireless communications apparatus.

20. An interface mediator as claimed in claim 18 wherein said first device is an infrared communications apparatus.

21. An interface mediator as claimed in claim 18 wherein said first device comprises switched contacts under the control of data from said first computing device port.

22. An interface mediator as claimed in claim 18 wherein said first device comprises electrical power provision apparatus.

23. An interface mediator as claimed in claim 18 wherein said first device is a display apparatus.

24. An interface mediator as claimed in claim 18 wherein said first device is a printer apparatus.

25. The interface mediator as claimed in claim 1 wherein said first computing device port is a network port.

26. An interface mediator as claimed in claim 25 wherein said first device is a telephony network interface apparatus.

27. An interface mediator as claimed in claim 26 wherein said telephony network interface apparatus comprises a modem.

28. An interface mediator as claimed in claim 25 wherein said first device is a digital network interface apparatus.

29. An interface mediator as claimed in claim 25 wherein said first device is a wireless network interface apparatus.

30. An interface mediator as claimed in claim 1 further comprising:
a plurality of mediator port pairs, each pair having one port of the pair for connecting to a port of a device and the other associated port of the pair for connecting to a port of said computing device associated with said device; and wherein
said second processing unit can mediate data communicated between computing device port and said associated device.

31. An interface mediator as claimed in claim 1 further comprising:
a separate signal mediating unit adapted to be mounted within said computing device having
an input connector;
an output connector;
at least one of sensing or disconnect means between input and output connector; and
communication means between separate signal mediating unit for said second processing unit to communicate with said at least one of sensing or disconnect means.

32. An interface mediator as claimed in claim 31 further comprising:
a plurality of input and output connector pairs, each of such pairs connected to at least one associated sensing or disconnect means, wherein said sensing or disconnect means may communicate with said second processing unit.

33. An interface mediator as claimed in claim 1 further comprising:
a third mediator port connected to a trigger device.

34. An interface mediator as claimed in claim 33 wherein said trigger device is an acoustic sensing means.

35. An interface mediator as claimed in claim 33 wherein said trigger device is an optical radiation sensing means.

36. An interface mediator as claimed in claim 33 wherein said trigger device is a radio signal sensing means.

37. An interface mediator as claimed in claim 33 wherein said trigger device is a tactile input sensing means.

38. An interface mediator as claimed in claim 37 wherein said tactile input sensing means is one of the group of a keyboard, a keypad, a touchpad, a slide pot, a knob, a pressure mat, a mouse, a trackball, and a data glove.

39. An interface mediator as claimed in claim 33 wherein said trigger device comprises a third information processor.
